(19) United States
(12) Patent Application Publication
(10) Pub. No.: US 2001/0022864 A1
(43) Pub. Date: Sep. 20, 2001

(54) Image processing apparatus and image processing program storage medium

(76) Inventor: Taiji Iwasaki, Kanagawa (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/793,961

(22) Filed: Feb. 28, 2001

(30) Foreign Application Priority Data
Feb. 29, 2000 (JP) 2000-053890

(51) Int. Cl. G06K 9/54; G06K 9/60

(52) U.S. Cl. 382/307

(57) ABSTRACT

An image processing apparatus has a script interpreting section for obtaining a script wherein an execution order for a plurality of image processes, which is permitted in a simultaneous execution, is represented in a predetermined form, and for interpreting the execution order represented by the script; and an image processing section for executing the plurality of image processes in accordance with the execution order interpreted by said script interpreting section.

### BACKGROUND OF THE INVENTION

1. Field of the Invention

The present invention relates to an image processing apparatus for performing an image processing, and an image processing program storage medium storing an image processing program which is incorporated in a computer system to be operated as an image processing apparatus.

2. Description of the Related Art

Hitherto, there is known an image processing apparatus in which various sorts of image processing are applied to image data representative of an original image to produce image data representative of a desired image. Particularly, in the field of prints and the like, there is needed a high definition of original image. For this reason, it is necessary to provide a large data size of original image, and also it is necessary for the image processing apparatus to perform a lot of computations for the image processing. In view of the foregoing, there is developed an image processing apparatus having a plurality of CPUs in which an image processing is carried out on a share basis by the CPUs to contribute to a higher speed of image processing.

In a development of an image processing apparatus having such a plurality of CPUs, a programmer designs an execution order for executing an image process on a share basis by the plurality of CPUs to produce a desired image data. A plurality of image processes, which are carried out in accordance with the designed execution order, are described (hard-coding) in form of a single program including execution contents of the image processes themselves. When the program is incorporated into the image processing apparatus and is carried out, the image processing is carried out in the execution order designed by the programmer.

As mentioned above, to contribute to a high speed image processing, the image processing is shared by the plurality of CPUs. However, in order to completely derive the ability of the image processing apparatus to fully implement the high speed image processing, there is a need to contribute to an optimization of the execution order in accordance with which the image processing is carried out on a share basis. And in order to contribute to such an optimization, there is a need to repeat such a series of work that a trial machine of the image processing apparatus is produced, an execution time for the image processing is tested, and the execution order is improved.

However, in the event that a plurality of image processes are described in form of a single program including execution contents of the image processes themselves, in order to improve the execution order, there is a need to reconsider and reproduce the program in its entirety including execution contents of the image processes themselves. This takes one trouble. Further, when the program is reproduced, there is a high possibility that a bug occurs.

As a result, there are required a lot of trouble and time for producing a new trial machine through an alteration of the execution order, and thus it takes a lot of time for obtaining the optimum execution order. This makes it easy to bring about a delay of a development of an image processing apparatus and an increment of a cost of the development.

Such a problem is associated with not only a field of a print, but also an image processing apparatus capable of executing an image processing in an execution order in which a simultaneous parallel execution and a sequential execution are mixed.

### SUMMARY OF THE INVENTION

In view of the foregoing, it is an object of the present invention to provide an image processing apparatus capable of easily performing an alteration of an execution order of an image processing, and an image processing program storage medium storing an image processing program which causes a computer system to operate as such an image processing apparatus.

To achieve the above-mentioned object, the present invention provides an image processing apparatus comprising:

a script interpreting section for obtaining a script wherein an execution order for a plurality of image processes, which is permitted in a simultaneous execution, is represented in a predetermined form, and for interpreting the execution order represented by the script; and

an image processing section for executing the plurality of image processes in accordance with the execution order interpreted by said script interpreting section.

According to the image processing apparatus of the present invention as mentioned above, the script interpreting section interprets the execution order represented by the script, and the image processing section executes the plurality of image processes in accordance with the execution order interpreted by said script interpreting section. This feature makes it possible for the image processing apparatus to separately incorporate therein individual programs associated with the plurality of image processes and the script representative of the order for the start of the programs, and thus the alteration of only the script permits to alter the execution order and thereby making it easy to alter the execution order.

To achieve the above-mentioned object, the present invention provides an image processing program storage medium storing an image processing program comprising:

script interpreting mean for obtaining a script wherein an execution order for a plurality of image processes, which is permitted in a simultaneous execution, is represented in a predetermined form, and for interpreting the execution order represented by the script; and

image processing means for executing the plurality of image processes in accordance with the execution order interpreted by said script interpreting means.

Said script interpreting section and said image processing section, which constitute said image processing apparatus, correspond to said script interpreting means and said image processing means, which constitute said image processing program, respectively. The script interpreting section and the image processing section indicate a coupling of the software with the hardware for their associated effect. On the other hand, the script interpreting means and the image processing means indicate only a software portion for their associated effect.

### BRIEF DESCRIPTION OF THE DRAWINGS

FIG. 1 is a schematic constitution view of a printing image and proof image producing system to which an embodiment of the present invention is applied.

FIG. 2 is a perspective view of a proofer including a personal computer.

FIG. 3 is a hardware structural view of the personal computer.

FIG. 4 is a functional block diagram of the personal computer.

FIG. 5 is a view showing an example of an execution order represented by a script.

FIG. 6 is a flowchart useful for understanding a procedure in which a personal computer interprets a script to execute an image processing.

FIG. 7 is a view showing an execution order improved in the execution order shown in FIG. 5.

FIG. 8 is a view showing an embodiment of an image processing program storage medium according to the present invention.

### DETAILED DESCRIPTION OF PREFERRED EMBODIMENTS

Embodiments of the present invention will be described with reference to the accompanying drawings.

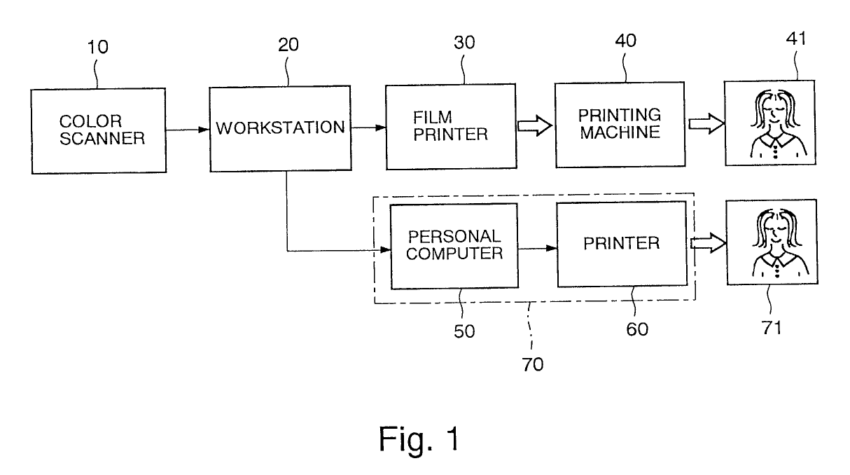

FIG. 1 is a schematic constitution view of a printing image and proof image producing system to which an embodiment of the present invention is applied.

A color scanner 10 reads an original image and produces color separation image data for CMYK four colors representative of the original image thus read. The image data for CMYK four colors is fed to a workstation 20. In the workstation 20, an operator performs an electronic page make-up in accordance with the fed image data to generate image data representative of an image for printing. The image data for printing represents an image consisting of pixels having gradation on each of the CMYK four colors. In the event that a printing is performed, the image data for printing is converted into image data for plate making representative of an image consisting of halftone dots and then fed to an image film printer 30 to produce a printing film original plate consisting of plates for CMYK associated with the image data for plate making.

A printing plate is produced from the printing film original plate, and then mounted on a printing machine 40. Ink is applied to the printing plate mounted on the printing machine 40. The ink thus applied is transferred to a printing paper so that a printed image 41 is formed on the printing paper.

Such a series of work that a film original plate is produced by the film printer 30, a printing plate is produced and mounted on the printing machine 40, and ink is applied to the printing plate mounted on the printing machine 40 to perform a printing on a paper, is large projects and also takes a lot of cost. For this reason, before the actual printing work is performed, a proofer 70, which comprises a personal computer 50 and a printer 60, is used to produce a proof image 71 in the manner as set forth below to confirm a finish of the printed image 41 beforehand.

To produce the proof image 71, image data for printing, which is produced by the electronic page make-up on the workstation 20, is fed to the personal computer 50 which is an example of the image processing apparatus. The personal computer 50 applies various sorts of image processing to the image data for printing so that the image data for printing is converted into proof image data for RGB three colors suitable for the printer 60 now intending to output the proof image 71. The personal computer 50 is provided with a plurality of CPUs which perform a various sorts of image processing on a share basis. The printer 60 receives the proof image data for RGB three colors obtained by the image processing and produces the proof image 71 in accordance with the received proof image data for RGB three colors.

The proofer 70 receives printing image data from the workstation 20 via the computer network, or by an MO disk (a magneto-optical disk).

An aspect of the printing image and proof image producing system to which an embodiment of the present invention is applied, as shown in FIG. 1, resides in the processing contents to be executed in the personal computer 50. Hereinafter, there will be described the personal computer 50.

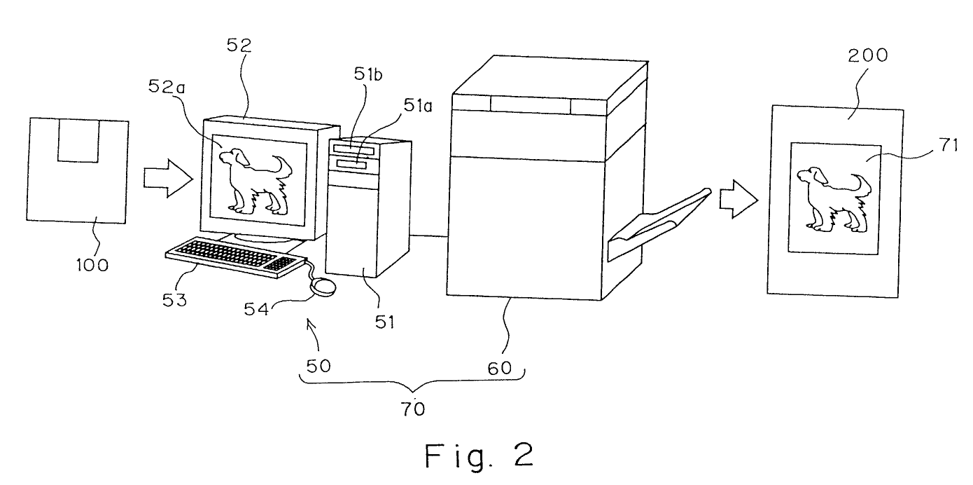

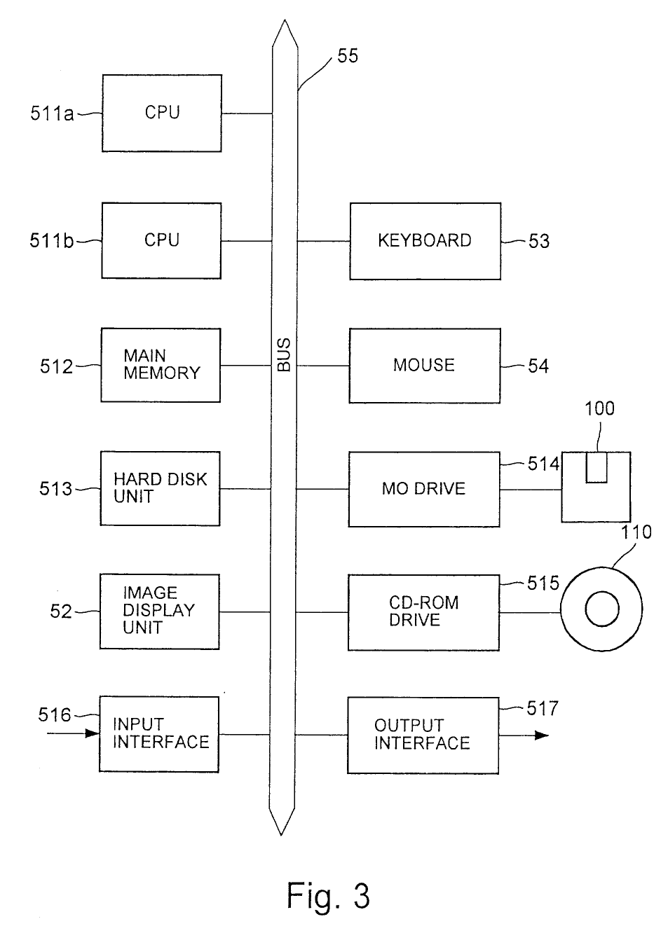

FIG. 2 is a perspective view of the proofer 70 including the personal computer 50. FIG. 3 is a hardware structural view of the personal computer 50.

The personal computer 50 comprises, on an external appearance, a main frame unit 51, an image display unit 52 for displaying an image on a display screen 52a in accordance with an instruction from the main frame unit 51, a keyboard 53 for inputting various sorts of information to the main frame unit 51 in accordance with a key operation, and a mouse 54 for inputting an instruction according to, for example, an icon and the like, through designation of an optional position on the display screen 52a, the icon and the like being displayed on the position on the display screen 52a. The main frame unit 51 has a floppy disk mounting slot 51a for mounting a floppy disk, and a CD-ROM mounting slot 51b for mounting a CD-ROM.

The printer 60 is a high definition printer for a proof image output, which receives image data from the personal computer 50 and outputs the proof image 71 on a sheet 200 in accordance with an instruction from the personal computer 50.

The main frame unit 51 comprises, as shown in FIG. 3, two CPU 511a and CPU 511b for executing an image processing on a share basis, a main memory 512 in which a program stored in a hard disk unit 513 is read out and developed for execution by the CPU 511a and the CPU 511b, said main memory 512 storing image data used for image processes in the CPU 511a and CPU 511b, the hard disk unit 513 for saving various types of programs and data, an MO drive 514 for accessing an MO disk 100 mounted thereon, a CD-ROM drive 515 for accessing a CD-ROM 110 mounted thereon, an input interface 516 connected to the workstation 20 (cf. FIG. 1), to receive image data from the workstation 20, and an output interface 517 to transmit image data to the printer 60. These various types of elements are connected via a bus 55 to the image display unit 52, the keyboard 53 and the mouse 54.

The CD-ROM 110 stores therein an image processing program for causing the personal computer 50 to operate as an image processing apparatus. The CD-ROM 110 is mounted on the CD-ROM drive 515 so that the image processing program, which is stored in the CD-ROM 110, is up-loaded on the personal computer 50 and is stored in the hard disk unit 513.

When the CD-ROM 110 stores therein an embodiment of the image processing program of the present invention, the CD-ROM 110 corresponds to the embodiment of the image processing program storage medium of the present invention. When the image processing program is up-loaded and stored in the hard disk unit 513, the hard disk unit 513, which is in a state that the image processing program is stored in the hard disk unit 513, also corresponds to the embodiment of the image processing program storage medium of the present invention. Further, in the event that the image processing program is down-loaded onto a floppy disk and the MO disk 100, the floppy disk and the MO disk 100, which are in a state that the image processing program is stored in therein, also correspond to the embodiment of the image processing program storage medium of the present invention.

Hereinafter, there will be described an operation as the image processing apparatus of the present invention in the personal computer 50.

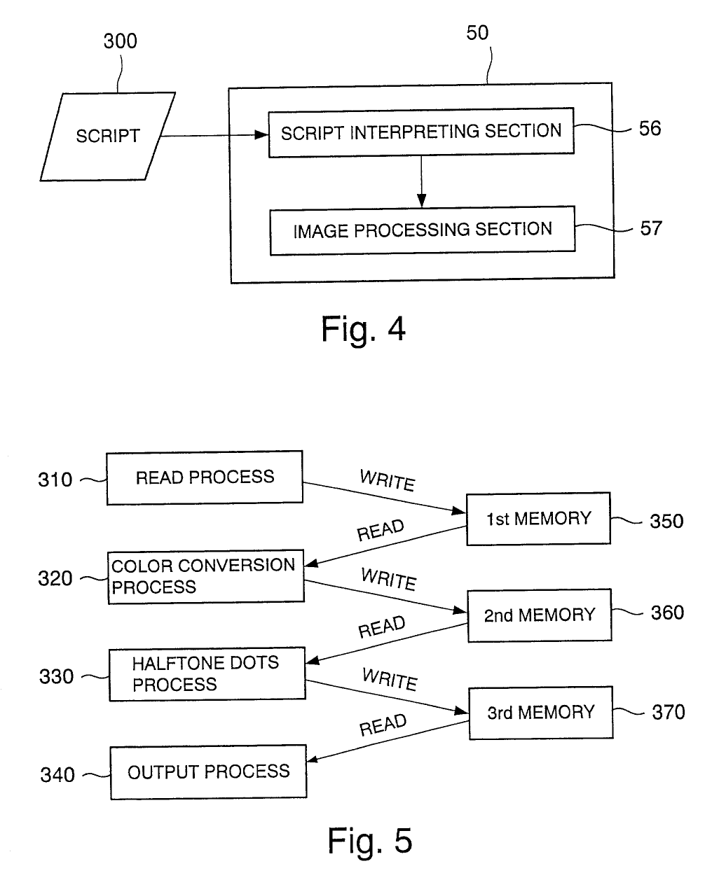

FIG. 4 is a functional block diagram of the personal computer.

In the personal computer 50, a script interpreting section 56 and an image processing section 57 are implemented. The script interpreting section 56 obtains a script 300 representative of an execution order for an image process, which will be described hereinafter, and interprets the execution order. The image processing section 57 executes various sorts of programs associated with various sorts of image processes in the hard disk unit in accordance with the execution order interpreted by the script interpreting section 56.

FIG. 5 is a view showing an example of an execution order represented by a script.

FIG. 5 shows a simple execution order in which a plurality of image processes are sequentially carries out by a single CPU.

According to the execution order shown in FIG. 5, a read process 310 for reading image data, a color conversion process 320 for converting colors of an image represented by image data, a halftone dots process 330 for converting an image constituted of a multi-level of pixels into an image constituted of a binary-level of halftone dots, and an output process 340 for outputting an image by a printer are sequentially carried out. The image data read by the read process 310 is written into a memory area used as a first memory 350. In the color conversion process 320, the image data written into the memory area of the first memory 350 is read to be subjected to a process, and the image data after the process is written into a memory area used as a second memory 360. In the halftone dots process 330, the image data written into the memory area of the second memory 360 is read to be subjected to a process, and the image data after the process is written into a memory area used as a third memory 370. In the output process 340, the image data written into the memory area of the third memory 370 is read and an image represented by the image data thus read is outputted.

Table 1 shows, by way of an example of a script, a script representative of the execution order shown in FIG. 5 in form of a list.

TABLE 1

| Address | Description | Supplementary Note |
|---|---|---|
| 001 | Read process | 015 |
| 002 | First memory | |
| 003 | Color conversion process | 016 017 |
| 004 | Second memory | |
| 005 | Halftone dots process | 018 019 |
| 006 | Third memory | |
| 007 | Output process | 020 |
| 008 | | |
| 009 | | |
| 010 | | |
| : | | |
| 015 | ┌001┘ is associated with ┌002┘ | |
| 016 | ┌002┘ is associated with ┌003┘ | |
| 017 | ┌003┘ is associated with ┌004┘ | |
| 018 | ┌004┘ is associated with ┌005┘ | |
| 019 | ┌005┘ is associated with ┌006┘ | |
| 020 | ┌006┘ is associated with ┌007┘ | |
| 021 | | |
| 022 | | |
| 023 | | |
| 024 | | |
| : | | |
| 030 | Sequential process | 034 |
| 031 | 001 | |
| 032 | 003 | |
| 033 | 005 | |
| 034 | 007 | |
| 035 | | |

The script shown in Table 1 includes an address column storing a series of addresses, a description column and a supplementary note column which are associated with the addresses.

For example, a description column for the address “001” of Table 1 stores therein a description (program names, etc.) defining a “read processing”. The personal computer can recognize contents of the “read processing” through such a description. For example, a description column for the address “002” of Table 1 stores therein a description (memory addresses, etc.) defining a memory area used as a “first memory”. The personal computer can recognize the “first memory” through such a description.

For example, a description column for the address “015” of Table 1 stores therein a description indicating that a process represented by the description of the address “001” is associated with a memory represented by the description of the address “002”. A numerical value representative of the address “015” indicative of the associated description is stored in the supplementary note area of the address “001”. Through those descriptions, the personal computer can recognize that the “read process” represented by the description of the address “001” is associated with the first memory represented by the description of the address “002”, and that the output destination of the “read process” is the first memory.

Likewise, for example, a description column for the address “003” of Table 1 stores therein a description defining a “color conversion process”, and a description column for the address “004” stores therein a description defining a memory area used as a “second memory”. Description columns for the addresses “016” and “017” stores therein descriptions indicating that the memory represented by the description of the address “002” is associated with a process represented by the description of the address “003”, and that the process represented by the description of the address “003” is associated with the memory represented by the description of the address “004”, respectively. Numerical values representative of the addresses “016” and “17” indicative of the associated description are stored in the supplementary note area of the address “003”. Through those descriptions, the personal computer can recognize that the “color conversion process” represented by the description of the address “003” is associated with the first and second memories represented by the descriptions of the addresses “002” and “004”, respectively, and that the input source of the “color conversion process” is the first memory, and the output destination of the “color conversion process” is the second memory.

A description column for the address “030” of Table 1 stores therein a description indicating that a series of processes, which are indicated by addresses after the address “030” in form of a list, are sequentially executed, and the last address “034” of the list is shown in the supplementary note area. In the list, there are indicated numerical values “001”, “003”, “005”, “007” for addresses associated with the processes to be sequentially executed. Through those descriptions, the personal computer can recognize that the “read process” represented by the description of the address “001”, the “color conversion process” represented by the description of the address “003”, the “halftone dots process” represented by the description of the address “005” and the “output process” represented by the descriptions of the address “007”, are sequentially carried out.

Hereinafter, there will be described a procedure that a personal computer interprets such a script and executes an image processing.

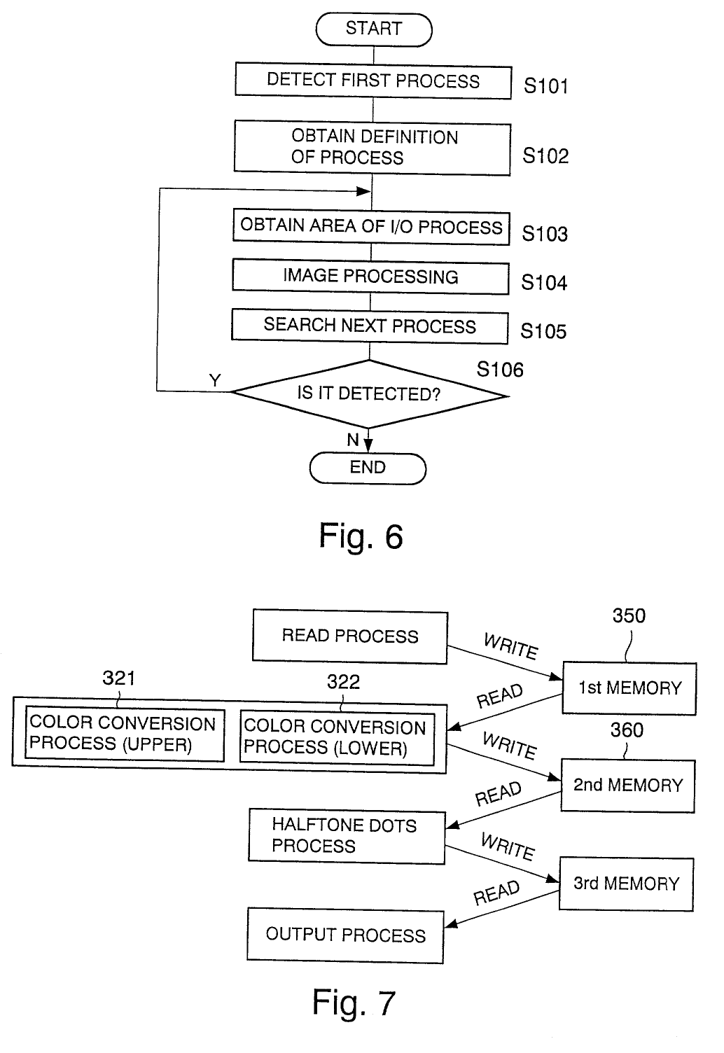

FIG. 6 is a flowchart useful for understanding a procedure in which a personal computer interprets a script to execute an image processing.

When the procedure starts, the script interpreting section detects an image process to be executed first (it may be a plurality of image processes to be simultaneously executed) in accordance with the above-mentioned list included in the script (step S101). For example, according to the script shown in Table 1, the description declaring the list is indicated on only the address “030”. Thus, the numerical value “001” indicated on the first stage of the list shown after the address “30” is detected as the numerical value indicative of an image process to be first carried out.

Next, the script interpreting section obtains the description defining the detected image process to recognize processing contents (step S102), and recognizes an area of a memory for input and output of image data at the time of execution of the image processing (step S103). For example, when the numerical value “001” is detected as the numerical value indicative of the image process, the “read process” indicated on the address “001” is recognized, and the address “002” is detected via the address “015” indicated by the numerical value “015” appearing on the supplementary note column of the address “001” so that a memory area of the first memory indicated on the address “002” is recognized.

In this manner, when the image process to be executed and the memory for input and output of image data are recognized, the recognized image process is executed by the image processing section and the image data is inputted and outputted to and from the recognized memory.

Thereafter, the script interpreting section reaches for an image process to be executed next in accordance with the above-mentioned list included in the script (step S105), and it is decided whether the image process to be executed is detected (step S106). When it is decided that the image process to be executed is detected, the process returns to the step S102 so that the above-mentioned procedure is repeated. When it is decided that the image process to be executed is not detected, the procedure is terminated.

In accordance with this procedure, the script as shown in Table 1 is interpreted, so that the image process is executed in the execution order as shown in FIG. 5.

Here, there will be described an alteration of the execution order.

FIG. 7 is a view showing an execution order improved in the execution order shown in FIG. 5.

The execution order shown in FIG. 7 is altered and improved from the execution order shown in FIG. 5 in the event that from a test result of the execution time by the trial machine, for example, it becomes clear that “the color conversion process 320 shown in FIG. 5 particularly takes a lot of time for the execution”.

The execution order shown in FIG. 7 incorporates thereinto, instead of the color conversion process 320 shown in FIG. 5, two color conversion processes 321 and 322 which are simultaneously executed by two CPUs. Those color conversion processes 321 and 322 are color conversion processes applied to the upper half of an image represented by image data written in the first memory 350 and the lower half of the image, respectively. The image data subjected to the color conversion processes 321 and 322 are written into the second memory 360 in form of the upper half of the image and the lower half of the image, respectively.

In this manner, when the execution order is altered and improved, it is possible to reduce the execution time. The alteration of the execution order as mentioned above causes the script shown in Table 1 to be altered into a script shown in Table 2 as set forth below.

TABLE 2

| Address | Description | Supplementary Note |
|---|---|---|
| 001 | Read process | 015 |
| 002 | First memory | |
| 003 | Color conversion process | 021 022 |
| 004 | Second memory | |
| 005 | Halftone dots process | 018 019 |
| 006 | Third memory | |
| 007 | Output process | 020 |
| 008 | First memory upper | |
| 009 | First memory lower | |
| 010 | Second memory upper | |
| 011 | Second memory lower | |
| 012 | Color conversion process | 023 024 |
| : | | |
| 015 | ┌001┘ is associated with ┌002┘ | |
| 016 | ┌002┘ is associated with ┌003┘ | |
| 017 | ┌003┘ is associated with ┌004┘ | |
| 018 | ┌004┘ is associated with ∉005┘ | |
| 019 | ┌005┘ is associated with ┌006┘ | |
| 020 | ┌006┘ is associated with ┌007┘ | |
| 021 | ┌003┘ is associated with ┌008┘ | |
| 022 | ┌003┘ is associated with ┌010┘ | |
| 023 | ┌009┘ is associated with ┌012┘ | |
| 024 | ┌011┘ is associated with ┌012┘ | |
| : | | |
| 030 | sequential process | |
| 031 | 001 | |
| 032 | 040 | 034 |
| 033 | 005 | |
| 034 | 007 | |
| 035 | | |
| : | | |
| 040 | parallel process | |
| 041 | 003 | |
| 042 | 012 | 042 |
| 043 | | |
| 044 | | |
| 045 | | |

As compared with the script shown in Table 1, the script shown in Table 2 additionally includes definitions of memory areas on the address “008” to the address “011”. On the address “008” and the address “009”, there are defined two memory areas of “first memory upper” and “first memory lower”, which divide the area of the first memory defined on the address “002” into two parts. On the address “010” and the address “011”, there are defined two memory areas of “second memory upper” and “second memory lower”, which divide the area of the second memory defined on the address “004” into two parts.

Further, as compared with the script shown in Table 1, the script shown in Table 2 additionally includes a definition of the “color conversion process” on the address “012” and descriptions of representative of associations between processes and memories on the address “021” to the address “024”. On the descriptions for the address “021” and the address “022”, there are provided associations between the “color conversion process” on the address “003” and the “first memory upper” and the “second memory upper”, respectively. The numerical values stored in the supplementary note column for the address “003” are altered into the numerical values representative of the address “021” and the address “022”. On the descriptions for the address “023” and the address “024”, there are provided associations between the “color conversion process” on the address “012” and the “first memory lower” and the “second memory lower”, respectively. The numerical values representative of the address “023” and the address “024” are stored in the supplementary note column for the address “012”. In this manner, it is possible to alter only the association between a process and a memory, without an alteration of the description defining processing contents of the “color conversion process”.

The description column of the address “40” of the script shown in Table 2 stores therein a description declaring that processes, which are shown in form of a list on addresses after the address “40”, are to be simultaneously executed, and the last address “042” of the list is shown in the supplementary note column. In the list, there are shown the numerical values “003” and “012” associated with the processes to be simultaneously executed. Through those descriptions, the personal computer can recognize that the “color conversion process” shown in the address “003” and the “color conversion process” shown in the address “012” are simultaneously carried out.

The numerical value stored in the description column of the address “032” is rewritten into the numerical value representative of the address “040” describing the declaration of the parallel process. Thus, the simple execution order shown in FIG. 5 is altered into such an execution order that first, the “read process” is carried out, next the two “color conversion processes” are simultaneously carried out, then the “halftone dots process” is carried out, and finally the “output process” is carried out.

Incidentally, the descriptions of the addresses “016” and “017” are not used and unnecessary, but there is no need to delete those descriptions particularly.

In this manner, only the modification of the script makes it possible to easily alter the execution order of the image process and improve the same, without altering a program representative of execution contents for the individual image processes.

Hereinafter, there will be described an embodiment of an image processing program storage medium of the present invention.

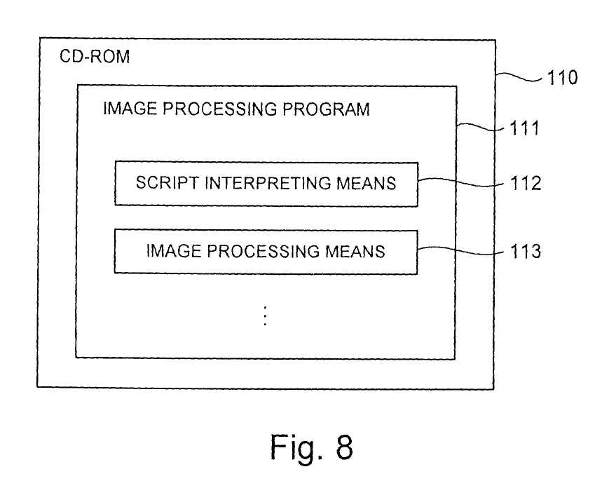

FIG. 8 is a view showing an embodiment of an image processing program storage medium according to the present invention.

As an embodiment of an image processing program storage medium according to the present invention, there is shown the CD-ROM 110 which stores an image processing program 111. The image processing program 111 comprises script interpreting means 112, image processing means 113 and other means.

The script interpreting means 112 serves as the script interpreting section 56 shown in FIG. 4. The image processing means 113 serves as the image processing section 57 shown in FIG. 4.

The other means of the image processing program 111 includes, for example, means for read a script from the MO disk 100 and the like, and means for displaying an image on the display screen 52.

When the CD-ROM 110 is mounted on the personal computer 50 shown in FIG. 2 so that the image processing program 111 is up loaded, the personal computer 50 serves as an embodiment of the image processing apparatus of the present invention.

As mentioned above, according to the present invention, it is possible to easily alter and improve the execution order of an image processing.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An image processing apparatus comprising:
a script interpreting section for obtaining a script wherein an execution order for a plurality of image processes, which is permitted in a simultaneous execution, is represented in a predetermined form, and for interpreting the execution order represented by the script; and
an image processing section for executing the plurality of image processes in accordance with the execution order interpreted by said script interpreting section.

2. An image processing program storage medium storing an image processing program comprising:
script interpreting mean for obtaining a script wherein an execution order for a plurality of image processes, which is permitted in a simultaneous execution, is represented in a predetermined form, and for interpreting the execution order represented by the script; and
image processing means for executing the plurality of image processes in accordance with the execution order interpreted by said script interpreting means.
